(19) United States
(12) Patent Application Publication
(10) Pub. No.: US 2025/0086844 A1
(43) Pub. Date: Mar. 13, 2025

(54) ELECTRONIC DEVICE FOR PROCESSING IMAGE BY USING AI ENCODING/DECODING, AND METHOD FOR CONTROLLING SAME

(71) Applicant: SAMSUNG ELECTRONICS CO., LTD., Suwon-si (KR)

(72) Inventors: Kiwon YOO, Suwon-si (KR); Kumran JI, Suwon-si (KR)

(73) Assignee: SAMSUNG ELECTRONICS CO., LTD., Suwon-si (KR)

(21) Appl. No.: 18/960,935

(22) Filed: Nov. 26, 2024

Related U.S. Application Data
(63) Continuation of application No. PCT/KR2023/006654, filed on May 17, 2023.

(30) Foreign Application Priority Data
Jul. 5, 2022 (KR) 10-2022-0082646

(51) Int. Cl. G06T 9/00

(52) U.S. Cl. CPC G06T 9/002

(57) ABSTRACT

An electronic device that processes an image by using artificial intelligence (AI) encoding that obtains a second image including luminance information based on a first image including pixel information, inputs the second image into the first neural network model and obtain a first residual image including luminance residual information, obtain a second residual image including pixel residual information based on the first residual image, obtains an AI-encoded image based on the first image and the second residual image, and transmits a compressed image obtained by encoding the AI-encoded image.

### CROSS-REFERENCE TO RELATED APPLICATIONS

This application is a bypass continuation application of International Application No. PCT/KR2023/006654 designating the United States, filed on May 17, 2023, in the Korean Intellectual Property Receiving Office and claiming priority to Korean Patent Application No. 10-2022-0082646, filed on Jul. 5, 2022, in the Korean Intellectual Property Office, the disclosures of which are incorporated by reference herein in their entireties.

### BACKGROUND

### 1. Field

The disclosure relates to an electronic device and a method for controlling the same, and more particularly, to an electronic device that processes an image by using AI encoding/decoding, and a method for controlling the same.

### 2. Description of the Related Art

A streaming method is a method by which a server transmits media in real time, and a terminal receives the media and reproduces the media in real time, and media is transmitted while its quality is adaptively changed based on a connection state of a network between a server-a terminal, and a specification of the terminal. For example, if network connection becomes unstable and an available band becomes lower, a service is performed by lowering the image quality, and when the connection becomes stabilized again and a sufficient band is guaranteed, a service is performed by improving the image quality.

Meanwhile, an AI system is a computer system implementing intelligence of a human level, and in the system, a machine can improve its ability by learning and determining by itself, unlike a conventional rule-based system. Recently, an AI system based on a deep neural network (DNN) is greatly overwhelming the performance of a conventional rule-based system, and its use is spreading in all fields. As there is a growing interest in an AI system, researches for improving service quality in image streaming are actively going on.

### SUMMARY

In accordance with an aspect of the disclosure, there is provided an electronic device configured to process an image by using artificial intelligence (AI) encoding, including: memory storing a first neural network model that is trained; a communication interface; and at least one processor configured, wherein the memory stores instructions that, when executed by the at least one processor, cause the electronic device to: obtain a second image including luminance information based on a first image including pixel information, input the second image into the first neural network model and obtain a first residual image including luminance residual information, obtain a second residual image including pixel residual information based on the first residual image, obtain an AI-encoded image based on the first image and the second residual image, and transmit, to an external device through the communication interface, a compressed image obtained by encoding the AI-encoded image.

The instructions, when executed by the at least one processor may cause the electronic device to: identify operation setting information of the first neural network model based on at least one of information about an image size of the second image, information about a network state, or information about a type of a codec, and input the second image into the first neural network model to which the identified operation setting information is applied, wherein the operation setting information may include: at least one of information about a number of layers of the first neural network model, information about a number of channels for each layer, information about a filter size, information about stride, information about pulling, or information about a parameter.

The instructions, when executed by the at least one processor may cause the electronic device to: identify the operation setting information of the first neural network model based on the information about the image size of the second image, the information about the network state, and the information about the type of the codec, and AI decoding information of the external device, wherein the AI decoding information of the external device may include: operation setting information of a second neural network model used in the AI decoding in the external device, and wherein the first neural network model is trained in association with the operation setting information of the second neural network model.

The instructions, when executed by the at least one processor may cause the electronic device to: perform downscaling of the first image and obtain a third image, and obtain the AI-encoded image based on the third image and the second residual image.

The first neural network model may be a model trained to perform downsampling of an image through AI encoding, and wherein the instructions, when executed by the at least one processor may cause the electronic device to: input the second image into the first neural network model and obtain the first residual image downsampled through the AI encoding, obtain the second residual image including pixel residual information based on the first residual image, and add pixel values included in the third image and pixel values included in the second residual image and obtain the AI-encoded image.

The luminance residual information includes YUV residual information, and wherein the instructions, when executed by the at least one processor may cause the electronic device to: obtain an R value, a G value, and a B value by applying conversion gains to a Y value, a U value, and a V value included in the first residual image, and identify the obtained R value, G value, and B value as the pixel residual information.

In accordance with an aspect of the disclosure, there is provided an electronic device configured to process an image by using artificial intelligence (AI) decoding, including: memory storing a trained second neural network model; a communication interface; and at least one processor, wherein the memory stores instructions that, when executed by the at least one processor cause the electronic device to: obtain a compressed image and AI encoding information through the communication interface, decode the compressed image and obtain a fourth image including pixel information, obtain a fifth image including luminance information based on the fourth image, input the fifth image into a second neural network model identified based on the AI encoding information and obtain a third residual image including luminance residual information, obtain a fourth residual image including pixel residual information based on the third residual image, and obtain an AI-decoded image based on the fourth image and the fourth residual image.

The instructions, when executed by the at least one processor may cause the electronic device to: identify operation setting information of the second neural network model based on the AI encoding information, and input the fifth image into the second neural network model to which the identified operation setting information is applied, and wherein the operation setting information may include: at least one of information about a number of layers of the second neural network model, information about a number of channels for each layer, information about a filter size, information on stride, information about pulling, or information about a parameter.

The instructions, when executed by the at least one processor may cause the electronic device to: perform upscaling of the fourth image and obtain a sixth image, and obtain the AI-decoded image based on the sixth image and the fourth residual image.

The second neural network model is a model trained to perform upsampling of an image through AI decoding, and wherein the instructions, when executed by the at least one processor may cause the electronic device to: input the fifth image into the second neural network model and obtain the third residual image upsampled through AI decoding, obtain the fourth residual image including pixel residual information based on the third residual image, and add pixel values included in the sixth image and pixel values included in the fourth residual image and obtain the AI-encoded image.

The luminance residual information includes YUV residual information, and wherein the instructions, when executed by the at least one processor may cause the electronic device to: obtain an R value, a G value, and a B value by applying conversion gains to a Y value, a U value, and a V value included in the third residual image, and identify the obtained R value, G value, and B value as the pixel residual information.

In accordance with an aspect of the disclosure, there is provided a method for controlling an electronic device configured to process an image by using artificial intelligence (AI) encoding, the method including: obtaining a second image including luminance information based on a first image including pixel information; inputting the second image into a first neural network model that is trained and obtaining a first residual image including luminance residual information; obtaining a second residual image including pixel residual information based on the first residual image; obtaining an AI-encoded image based on the first image and the second residual image; and transmitting, to an external device, a compressed image obtained by encoding the AI-encoded image.

The obtaining the first residual image may include: identifying operation setting information of the first neural network model based on at least one of information about an image size of the second image, information about a network state, or information about a type of a codec; and inputting the second image into the first neural network model to which the identified operation setting information is applied, and the operation setting information may include: at least one of information about a number of layers of the first neural network model, information about a number of channels for each layer, information about a filter size, information about stride, information about pulling, or information about a parameter.

The identifying the operation setting information of the first neural network model may include: identifying operation setting information of the first neural network model based on the information about the image size of the second image, the information about the network state, and the information about the type of the codec, and AI decoding information of the external device, and the AI decoding information of the external device may include: operation setting information of a second neural network model used in the AI decoding in the external device, and the first neural network model is trained in association with the operation setting information of the second neural network model.

In accordance with an aspect of the disclosure, there is provided a method for controlling an electronic device configured to process an image by using artificial intelligence (AI) decoding, the method including: receiving a compressed image and AI encoding information; decoding the compressed image and obtaining a fourth image including pixel information; obtaining a fifth image including luminance information based on the fourth image; inputting the fifth image into a second neural network model identified based on the AI encoding information and obtaining a third residual image including luminance residual information; obtaining a fourth residual image including pixel residual information based on the third residual image; and obtaining an AI-decoded image based on the fourth image and the fourth residual image.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a diagram for illustrating a method of processing an image according to AI encoding/decoding according to an embodiment of the disclosure;

FIG. 2 is a block diagram illustrating a configuration of an electronic device according to an embodiment of the disclosure;

FIG. 3 illustrates an example of operation setting information of an AI codec DNN according to an embodiment of the disclosure;

FIG. 4 is a flow chart for illustrating an operation of a first electronic device according to an embodiment of the disclosure;

FIG. 5 is a flow chart for illustrating an operation of a first electronic device according to an embodiment of the disclosure;

FIG. 6 and FIG. 7 are diagrams for illustrating in detail a method of generating an AI-encoded image according to an embodiment of the disclosure;

FIG. 8 is a block diagram illustrating a configuration of an electronic device according to an embodiment of the disclosure;

FIG. 9 is a flow chart for illustrating an operation of a second electronic device according to an embodiment of the disclosure;

FIG. 10 is a flow chart for illustrating an operation of a second electronic device according to an embodiment of the disclosure; and

FIG. 11 is a diagram for illustrating in detail a method of generating an AI-encoded image according to an embodiment of the disclosure.

### DETAILED DESCRIPTION

Hereinafter, the disclosure will be described in detail with reference to the accompanying drawings.

As terms used in the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, terms such as “first,” “second” and the like may be used to describe various elements, but the terms are not intended to limit the elements. Such terms are used only to distinguish one element from another element.

In addition, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, the expression “at least one of A or B” should be interpreted to mean any one of “A” or “B” or “A and B.”

In addition, in the disclosure, “a module” or “a part” performs at least one function or operation, and may be implemented as hardware or software, or as a combination of hardware and software. Further, a plurality of “modules” or “parts” may be integrated into at least one module and implemented as at least one processor (not shown), except “modules” or “parts” which need to be implemented as specific hardware.

Hereinafter, one or more embodiments of the disclosure will be described in detail with reference to the accompanying drawings, such that a person having ordinary knowledge in the technical field to which the disclosure belongs can easily carry out the one or more embodiments. However, the disclosure may be implemented in several different forms, and is not limited to the embodiments described herein. Also, in the drawings, parts that are not related to explanation of the disclosure were omitted, for explaining the disclosure clearly, and throughout the specification, similar components were designated by similar reference numerals.

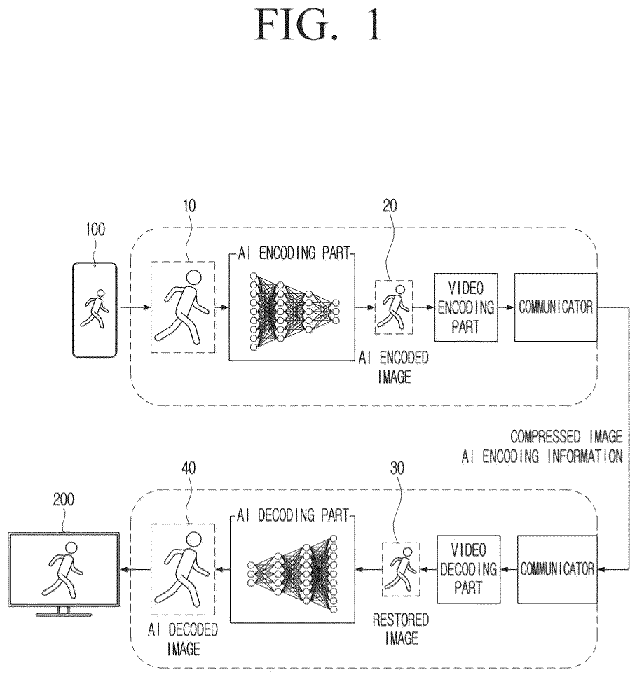

FIG. 1 is a diagram for illustrating a method of processing an image according to AI encoding/decoding according to an embodiment of the disclosure.

For streaming an image of a high definition/a high resolution such as 4K, 8K, etc., through a network, an image encoding technology and an up/down scaling technology that can reduce a required bandwidth of the network are important. For an image encoding technology, standard codecs such as H.264/265, VP8/9, and AV1 are being used widely, and in the case of OTT companies, they are servicing 4K images by compressing the images to about 15 Mbps based on H.265. For servicing images to fit different network environments of each user, the images should be compressed in image resolutions and transmission rates in various combinations, and a technology used in this case is an up/down scaling technology. For example, when trying to transmit an 8K image in a level of about 15 Mbps, a transmission terminal 100 may perform AI encoding of an image 10 (e.g., down-scaling the resolution to 4K) and obtain an AI encoded image 20, and perform video encoding of the AI encoded image 20. Afterwards, the transmission terminal 100 may transmit the compressed image compressed through the video encoding and information on the AI encoding to the reception terminal 200 through a communicator.

When the compressed image and the information on the AI encoding are received through the communicator, the reception terminal 200 may perform video encoding of the compressed image and obtain a restored image 30, and perform AI decoding of the restored image 30 (e.g., up-scaling the resolution to 8K) and obtain an AI decoded image 40. When performing up/down scaling, a simple interpolation method such as bi-linear or bi-cubic may be used, but recently, up/down scaling is performed by using a neural network model, and the image quality felt by consumers could thereby be further improved. In particular, this method has an advantage of being easily compatible no matter what kind of compression codec is used, and thus the method can be easily expanded by being applied to a H.265/VP9 standard codec that is widely used currently.

Meanwhile, a neural network model used in AI encoding and decoding, e.g., a DNN model may make determination based on an image resolution and a network state, and the type of a codec, and here, both of a server and a TV can support the maximum performance with AI operation processing using a high performance processor or hardware acceleration, and can use an external power, and thus power consumption does not become a big problem.

In general, a neural network model used in AI encoding and decoding has a processing structure for an image of a color gamut separated into luminance/chroma channels such as a YUV. However, there is a problem that, while such a neural network model is appropriate for viewing contents such as general broadcasting/OTT/web images, it is not appropriate for RGB images of graphics/synthesis such as a computer/a console. As an example, in case a DNN model is applied to all channels, there is a problem that, while the performance may be good, the cost is not effective. As another example, in case a DNN model is applied to a channel of a specific color (e.g.: G), there is a problem that a side effect may be generated as only the channel is emphasized, and the entire improved effect is also reduced. As still another example, in the case of converting a color gamut of a YUV and performing processing, there is a problem that degradation due to data loss in a color gamut conversion process is generated.

Accordingly, hereinafter, various embodiments regarding AI encoding/decoding methods that can correspond to various three-dimensional color coordinates will be explained.

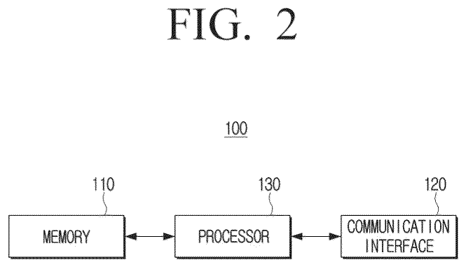

FIG. 2 is a block diagram illustrating a configuration of an electronic device according to an embodiment of the disclosure.

According to FIG. 2, the electronic device 100 includes memory 110, a communication interface 120, and a processor 130.

According to an embodiment, as the electronic device 100 (referred to as a first electronic device hereinafter), any device equipped with an image processing function and/or a display function such as a TV, a smartphone, a tablet PC, a laptop PC, a consol, a set-top, a monitor, a PC, a camera, a camcorder, a large format display (LFD), digital signage, a digital information display (DID), a video wall, etc. can be applied without limitation. According to an embodiment, the first electronic device 100 may function as the transmission terminal 100 in FIG. 1, and may perform AI encoding of an image and transmit the image to an external device, i.e., the reception terminal 200 in FIG. 2.

The memory 110 may be electrically connected with the processor 130, and may store data necessary for various embodiments of the disclosure. The memory 110 may be implemented in a form of memory embedded in the first electronic device 100, or implemented in a form of memory that can be attached to or detached from the first electronic device 100 according to the usage of stored data. For example, in the case of data for operating the first electronic device 100, the data may be stored in memory embedded in the first electronic device 100, and in the case of data for an extended function of the first electronic device 100, the data may be stored in memory that can be attached to or detached from the first electronic device 100. Meanwhile, in the case of memory embedded in the first electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the first electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

According to an embodiment, the memory 110 may store a computer program including at least one instruction or instructions for controlling the first electronic device 100.

According to an embodiment, the memory 110 may store an image received from an external device (e.g., a source device), an external storage medium (e.g., a USB), an external server (e.g., a webhard), etc., i.e., an input image. Alternatively, the memory 110 may store an image obtained through a camera (not shown) provided on the first electronic device 100.

According to an embodiment, the memory 110 may store information on a neural network model (or, an artificial intelligence model) including a plurality of layers. Here, the feature of storing information on a neural network model may mean storing various types of information related to the operations of the neural network model, e.g., information on a plurality of layers included in the neural network model, information on parameters (e.g., filter coefficients, biases, etc.) used in each of the plurality of layers, etc. For example, the memory 110 may store information on a first neural network model that was trained to perform AI encoding according to an embodiment. Here, the first neural network model may be implemented as, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but is not limited thereto. Here, the feature that a neural network model is trained means that a basic neural network model (e.g., an artificial intelligence model including any random parameters) is trained by using a plurality of training data by a learning algorithm, and predefined operation rules or a neural network model set to perform a desired characteristic (or, a purpose) is thereby made. Such learning may be performed through a separate server and/or a system, but the disclosure is not limited thereto, and the learning may be performed at the electronic device. As examples of learning algorithms, there are supervised learning, unsupervised learning, semi-supervised learning, or reinforcement learning, but learning algorithms are not limited to the aforementioned examples.

According to an embodiment, the memory 110 may store various kinds of information necessary for image quality processing, e.g., information, an algorithm, an image quality parameter, etc. for performing at least one of noise reduction, detail enhancement, tone mapping, contrast enhancement, color enhancement, or frame rate conversion. Also, the memory 110 may store a final output image generated by image processing.

According to an embodiment, the memory 110 may be implemented as single memory that stores data generated in various operations according to the disclosure. Meanwhile, according to an embodiment, the memory 110 may also be implemented to include a plurality of memories that respectively store data of different types, or respectively store data generated in different steps.

The communication interface 120 may be a component that performs communication with an external device 200 (referred to as a second electronic device hereinafter). For example, the communication interface 120 may transmit or receive an image signal by a streaming or download method from an external device (e.g., a source device), an external storage medium (e.g., a USB memory), an external server (e.g., a webhard), etc. through communication methods such as AP-based Wi-Fi (Wi-Fi, a wireless LAN network), Bluetooth, Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc.

In the aforementioned embodiment, it was explained that various types of data is stored in the external memory 110 of the processor 130, but at least some of the aforementioned data may be stored in internal memory of the processor 130 according to an implementation example of at least one of the first electronic device 100 or the processor 130.

The at least one processor 130 (referred to as the processor hereinafter) is electrically connected with the memory 110 and controls the overall operations of the first electronic device 100. The at least one processor 130 may consist of one or a plurality of processors. Here, the one or plurality of processors may be implemented as at least one software or at least one hardware, or a combination of at least one software and at least one hardware. According to an embodiment, software or hardware logic corresponding to the at least one processor may be implemented in one chip. According to an embodiment, software or hardware logic corresponding to some of the plurality of processors may be implemented in one chip, and software or hardware logic corresponding to the remaining processors may be implemented in another chip.

Specifically, the processor 130 may perform operations of the first electronic device 100 according to various embodiments of the disclosure by executing the at least one instruction stored in the memory 110.

According to an embodiment, the processor 130 may be implemented as a digital signal processor (DSP) processing digital image signals, a microprocessor, a graphics processing unit (GPU), an artificial intelligence (AI) processor, a neural processing unit (NPU), and a time controller (TCON). However, the disclosure is not limited thereto, and the processor 130 may include one or more of a central processing unit (CPU), a micro controller unit (MCU), a micro processing unit (MPU), a controller, an application processor (AP), or a communication processor (CP), and an ARM processor, or may be defined by the terms. Also, the processor 130 may be implemented as a system on chip (SoC) having a processing algorithm stored therein or large scale integration (LSI), or implemented in the form of an application specific integrated circuit (ASIC) or a field programmable gate array (FPGA).

Also, the processor 130 for executing a neural network model according to an embodiment may be implemented through a combination of a generic-purpose processor such as a CPU, an AP, a digital signal processor (DSP), etc., a graphic-dedicated processor such as a GPU and a vision processing unit (VPU), or an artificial intelligence-dedicated processor such as a neural processing unit (NPU) and software. The processor 130 may perform control to process input data according to the predefined operation rules or the neural network model stored in the memory 110. Alternatively, in case the processor 130 is a dedicated processor (or an artificial intelligence-dedicated processor), the processor 130 may be designed as a hardware structure specified for processing of a specific neural network model. For example, hardware specified for processing of a specific neural network model may be designed as a hardware chip such as an ASIC, an FPGA, etc. In case the processor 130 is implemented as a dedicated processor, the processor 130 may be implemented to include memory for implementing the embodiments of the disclosure, or implemented to include a memory processing function for using external memory.

According to an embodiment, the processor 130 may obtain an AI encoded image by inputting an image (e.g., an input image) into the trained first neural network model, and encode the AI encoded image (or perform first encoding or video encoding) and obtain a compressed image (or an encoded image). Here, the first neural network model may be implemented as a first DNN according to an embodiment, but is not limited thereto. However, hereinafter, a case wherein the first neural network model is implemented as the first DNN will be assumed, for the convenience of explanation.

An encoding (or the first encoding or video encoding) process may include a process of generating prediction data by predicting a compressed image, a process of generating residual data corresponding to a difference between the compressed image and the prediction data, a process of transforming the residual data which is a spatial area component into a frequency area component, a process of quantizing the residual data transformed into a frequency area component, and a process of performing entropy encoding of the quantized residual data, etc. Such an encoding process may be implemented through one of image compression methods using frequency conversion such as MPEG-2, H.264 Advanced Video Coding (AVC), MPEG-4, High Efficiency Video Coding (HEVC), VC-1, VP8, VP9, and AOMedia Video 1 (AV1), etc.

Then, the processor 130 may transmit the compressed image and AI encoding information related to the first neural network model to the second electronic device 200, e.g., an AI decoding device through the communication interface 120. The AI encoding information may be transmitted together with the image data of the compressed image. Alternatively, depending on implementation examples, the AI encoding information may be transmitted while being distinguished from the image data in a form of a frame or a packet. The image data and the AI encoding information may be transmitted through the same network or different networks.

Here, the AI encoding information may include information on whether AI encoding processing was performed and operation setting information related to the AI encoding (referred to as AI encoding operation setting information or first DNN operation setting information hereinafter). For example, the AI encoding operation setting information may include at least one of information on the number of layers of the first neural network model (or the first DNN), information on the number of channels for each layer, information on a filter size, information on stride, information on pulling, or information on a parameter.

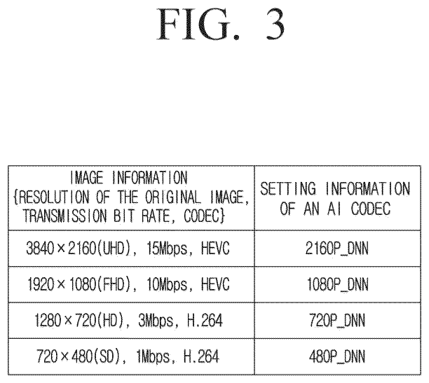

According to an embodiment, the first neural network model, e.g., the first DNN may be trained based on an image size, a network state, the type of a codec, etc. in a transmission terminal/a reception terminal. Also, the first DNN may be trained in association with not only an encoding process, but also a decoding process of the second neural network model used in the AI decoding device. For example, the first DNN may be trained in mutual association to minimize data loss and degradation of visual recognition, etc. that may be generated in downscaling/upscaling and compression/restoration in an encoding process and a decoding process. FIG. 3 illustrates an example of operation setting information of an AI codec DNN according to an embodiment of the disclosure. For example, if an input image is of UHD and the bit rate is 15 Mbps, 2160P_DNN operation setting information may be used in AI encoding, and HEVC may be used in video encoding/decoding. Alternatively, if an image is of HD and the bit rate is 3 Mbps, 720P_DNN operation setting information may be used in AI encoding, and H.264 may be used in video encoding/decoding.

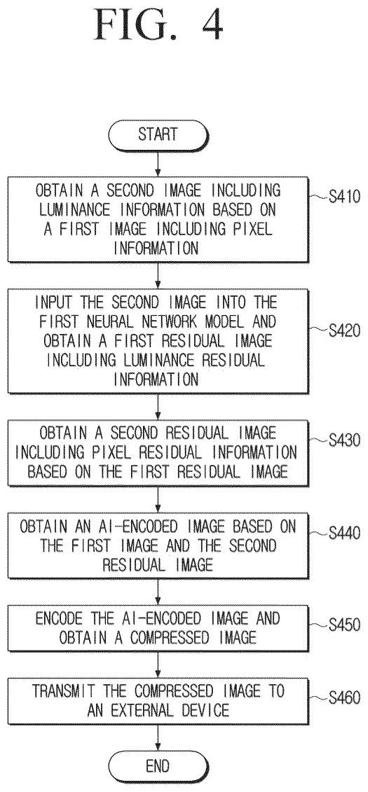

FIG. 4 is a flow chart for illustrating an operation of a first electronic device according to an embodiment of the disclosure.

According to FIG. 4, the processor 130 may obtain a second image including luminance information based on a first image including pixel information in operation S410. For example, the pixel information may be R/G/B information, and accordingly, the first image may be implemented as an RGB image. The luminance information may include a Y value, and accordingly, the second image may be implemented as various images including the Y value. For example, the second image may be an RGB-Y image, but is not necessarily limited thereto.

Then, the processor 130 may input the second image into a first neural network model, and obtain a first residual image including luminance residual information in operation S420. Here, the first neural network model may be a model that was trained to output a corresponding luminance residual image when an image including luminance information is input. For example, the first neural network model may be a model that was trained to output a luminance residual image by performing downsampling of an image through AI encoding. A luminance residual image may mean an image including only luminance residual information. Here, the luminance residual information may include information according to a luminance difference between an input image (e.g., the second image) and a reference image. For example, the luminance residual information may include YUV (luminance Y and chroma U/V) residual information.

According to an embodiment, the processor 130 may identify operation setting information of the first neural network model based on at least one of information on an image size of the second image (and/or the first image), information on a network state, or information on a type of a codec. According to an embodiment, the processor 130 may identify operation setting information of the first neural network model based on the information on the image size of the second image, the information on the network state, and the information on the type of the codec, and AI decoding information of an external device, i.e., the second electronic device 200. Here, the AI decoding information of the second electronic device 200 may include operation setting information of a second neural network model used in AI decoding in the second electronic device 200. Meanwhile, the first neural network model may be trained in association with the operation setting information of the second neural network model.

Then, the processor 130 may identify the first neural network model to which the identified operation setting information is applied. Here, the operation setting information may include at least one of information on the number of layers of the first neural network model, information on the number of channels for each layer, information on a filter size, information on stride, information on pulling, or information on a parameter.

Then, the processor 130 may obtain a second residual image including pixel residual information based on the first residual image in operation S430. For example, the processor 130 may convert the luminance residual information included in the first residual image into pixel residual information, and obtain the second residual image. For example, the luminance residual information may include YUV residual information. According to an embodiment, the processor 130 may obtain an R value, a G value, and a B value by applying conversion gains to a Y value, a U value, and a V value included in the first residual image, and obtain the obtained R value, G value, and B value as the pixel residual information.

Then, the processor 130 may obtain an AI-encoded image based on the first image and the second residual image in operation S440.

Then, the processor 130 may encode the AI-encoded image and obtain a compressed image in operation S450. For example, the processor 130 may obtain a compressed image by converting the AI-encoded image into a compressed image in a binary data format. For example, compression of an image may be performed according to a general video compression method, e.g., H.264, HEVC, VP9, AV1, VVC, etc. However, the disclosure is not limited thereto, and encoding of the AI-encoded image may be performed through one of various compression methods such as moving picture experts group (MPEG) (e.g., MP2, MP4, MP7, etc.), joint photographic coding experts group (JPEG), advanced video coding (AVC), H.264, H.265, high efficiency video codec (HEVC), VC-1, VP8, VP9, and AOMedia Video 1 (AV1), etc.

Afterwards, the processor 130 may transmit the obtained compressed image to the second electronic device 200 in operation S460. According to an embodiment, the processor 130 may transmit the compressed image and the AI encoding information to the second electronic device 200. The AI encoding information may be transmitted together with image data of the compressed image. Alternatively, depending on implementation examples, the AI encoding information may be transmitted while being distinguished from the image data in a form of a frame or a packet. The image data and the AI encoding information may be transmitted through the same network or different networks. Here, the AI encoding information may include information on whether AI encoding processing was performed and operation setting information related to the AI encoding (referred to as AI encoding operation setting information or first DNN operation setting information hereinafter). For example, the AI encoding operation setting information may include at least one of information on the number of layers of the first neural network model (or the first DNN), information on the number of channels for each layer, information on a filter size, information on stride, information on pulling, or information on a parameter.

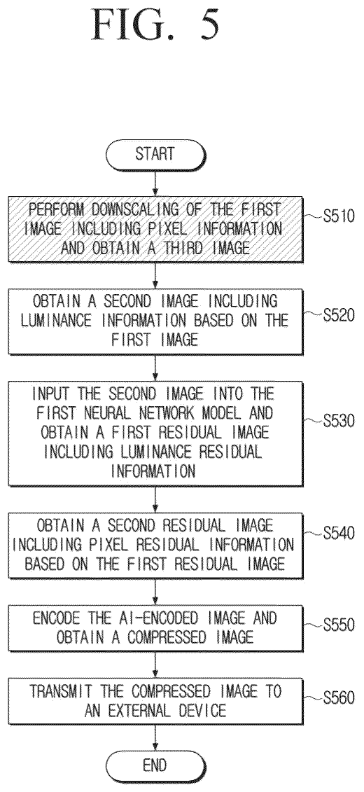

FIG. 5 is a flow chart for illustrating an operation of a first electronic device according to an embodiment of the disclosure.

According to FIG. 5, the processor 130 may perform downscaling of the first image including pixel information and obtain a third image in operation S510. According to an embodiment, the processor 130 may determine a downscaling ratio of the first image based on the downsampling ratio of the first neural network model. For example, at least one interpolation method among bilinear interpolation, nearest neighbor interpolation, bicubic interpolation, deconvolution interpolation, subpixel convolution interpolation, polyphase interpolation, trilinear interpolation, and linear interpolation may be used as the downscaling method.

The processor 130 may obtain a second image including luminance information based on the first image in operation S515. As the operation S515 is identical to the operation S410 illustrated in FIG. 4, detailed explanation will be omitted.

The processor 130 may input the second image into the first neural network model, and obtain a first residual image including luminance residual information in operation S520. According to an embodiment, the processor 130 may input the second image into the first neural network model, and obtain a first residual image that was downsampled through AI encoding. For example, the first residual image may be an image that was downsampled in the same ratio as the downscaling ratio in the operation S510.

The processor 130 may obtain a second residual image including pixel residual information based on the first residual image in operation S530. As the operation S530 is identical to the operation S430 illustrated in FIG. 4, detailed explanation will be omitted.

The processor 130 may obtain an AI-encoded image based on the third image and the second residual image obtained in the operation S510 in operation S540. As an example, the processor 130 may add pixel values included in the third image and pixel values included in the second residual image, and obtain an AI-encoded image. For example, the processor 130 may add each of pixel values included in the third image and pixel values included in the second residual image, and obtain an AI-encoded image of which size is identical to the sizes of the third image and the second residual image.

The processor 130 may encode the AI-encoded image and obtain a compressed image in operation S550. As the operation S550 is identical to the operation S450 illustrated in FIG. 4, detailed explanation will be omitted.

Afterwards, the processor 130 may transmit the obtained compressed image to the second electronic device 200 in operation S560. As the operation S560 is identical to the operation S460 illustrated in FIG. 4, detailed explanation will be omitted.

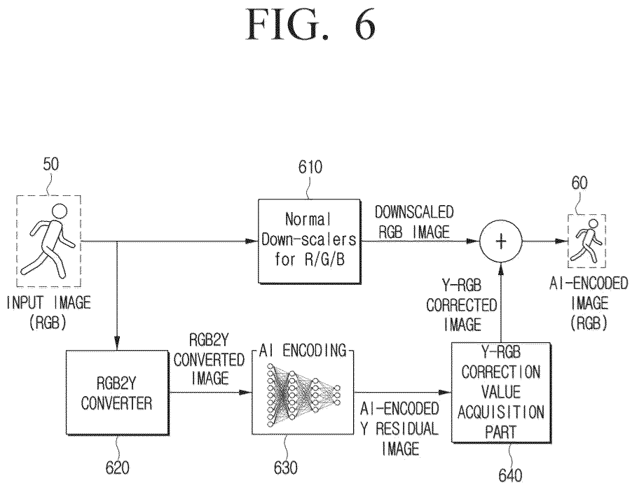

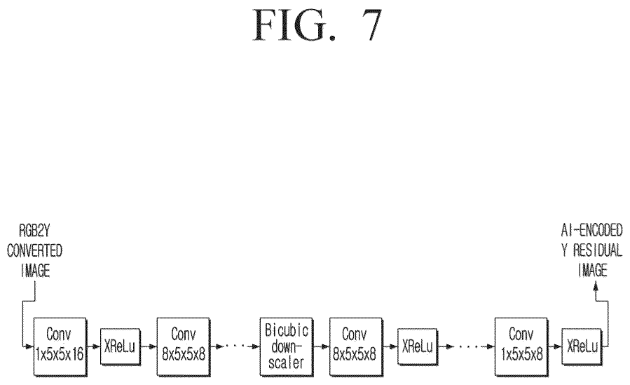

FIG. 6 and FIG. 7 are diagrams for illustrating in detail a method of generating an AI-encoded image according to an embodiment of the disclosure.

According to FIG. 6, the processor 130 may perform downscaling of an input image, e.g., an RGB image 50 (the first image) by using a normal downscaler 610, and obtain a downscaled RGB image (a third image). Also, the processor 130 may convert the input image, i.e., the RGB image 50 (the first image) into an RGB-Y image (a second image) including luminance information by using an RGB2Y converter 620. The RGB2Y converter 620 may obtain luminance information for a plurality of color channels including RGB.

The processor 130 may input the RGB-Y converted image (the second image) into a first neural network model 630 for AI encoding, and obtain an AI-encoded Y residual image (a first residual image). Here, the AI-encoded Y residual image may be an AI-encoded residual image regarding luminance. For example, the first neural network model 630 may be a model that was trained to output an AI-encoded Y residual image (a first residual image) through AI encoding when an RGB-Y converted image (a second image) is input as illustrated in FIG. 7. For example, the first neural network model 630 may be a deep neural network structure based on a ResNet for processing AI encoding. In the structure, a network consisting of a plurality of parallel layers and xReLu activation functions may be aligned, and a CNN result of the previous layer may be added to an input of the next layer, and the size of the layer may be extended. As illustrated in the drawing, each layer may generate an AI-encoded residual image through consecutive CNN processing by using eight channels and 5×5 filters, but the disclosure is not limited thereto.

The processor 130 may obtain a Y-RGB corrected image (a second residual image) from the AI-encoded Y residual image (the first residual image) by using a Y-RGB correction value acquisition part 640. For example, the Y-RGB correction value acquisition part 640 may obtain a Y-RGB corrected image by applying a predefined formula, an algorithm, etc. to pixel values included in an input RGB image. The Y-RGB corrected image may be an image including a correction value corresponding to a contribution amount of a luminance signal when converting the AI-encoded Y residual image into the original color gamut.

According to an embodiment, in the case of using a conversion formula of BT.709 as in the following formula 1, the correction ratios of the AI-encoded Y residual image (the first residual image) for each of the R/G/B channels are 1:1:1, and the Y residual image can be scaled.

$$[ \begin{matrix}R \\ G \\ B\end{matrix} ] = [ \begin{matrix}1 & 0 & 1.28033 \\ 1 & - 0.21482 & - 0.38059 \\ 1 & 2.12798 & 0\end{matrix} ] [ \begin{matrix}Y \\ U \\ V\end{matrix} ] \qquad [ Formula 1 ]$$

The processor 130 may add the pixel values of the downscaled RGB image (the third image) and the Y-RGB corrected image (the second residual image), and obtain an AI-encoded image 60 (an RGB image).

According to an embodiment, the first neural network model may be trained in association with the second neural network model provided in the second electronic device 200, i.e., a model performing AI upscaling. That is, the first neural network model may be trained in association with the operation setting information of the second neural network model. This is because, in case a neural network model for AI downscaling and a neural network model for AI upscaling are separately trained, a difference between an image which is a subject for AI encoding and an image restored through AI decoding in the second electronic device 200 may become big.

According to an embodiment, for maintaining such a relation of association in an AI encoding process of the first electronic device 100 and an AI decoding process of the second electronic device 200, AI decoding information and AI encoding information may be used. Accordingly, the AI encoding information obtained through the AI encoding process may include information on an upscaling target, and in the AI decoding process, an image may be upscaled according to the information on the upscaling target that is identified based on the AI encoding information. Here, the AI encoding information may include whether AI encoding processing of the image will be performed, and a target upscaling resolution.

According to an embodiment, the neural network model for AI downscaling and the neural network model for AI upscaling may be implemented as deep neural networks (DNNs). For example, the first DNN for AI downscaling and the second DNN for AI upscaling are trained in association through sharing of loss information under a predetermined target, and thus the first electronic device 100, i.e., the AI encoding device may provide target information used when the first DNN and the second DNN were trained in association to the second electronic device 200, i.e., the AI decoding device, and the external device, i.e., the AI decoding device may perform AI upscaling of the image to the target resolution based on the provided target information.

Meanwhile, although not illustrated in FIG. 2, the first electronic device 100 can obviously further include components such as a display (not shown), a user interface (not shown), a speaker (not shown), a camera (not shown), etc. depending on implementation examples.

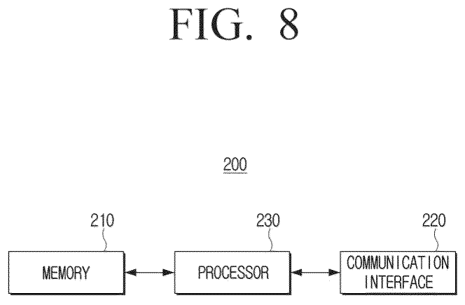

FIG. 8 is a block diagram illustrating a configuration of an electronic device according to an embodiment of the disclosure.

According to FIG. 8, the electronic device 200 includes 210, a communication interface 220, and a processor 230.

According to an embodiment of the disclosure, the electronic device 200 (referred to as the second electronic device hereinafter) may be implemented as a TV, but is not limited thereto, and any device equipped with an image processing function and/or a display function such as a smartphone, a tablet PC, a laptop PC, a consol, a set-top, a monitor, a PC, a camera, a camcorder, a large format display (LFD), digital signage, a digital information display (DID), a video wall, etc. can be applied without limitation. According to an embodiment, the second electronic device 200 may function as the reception device, and may perform AI decoding of an AI-encoded image received from the first electronic device 100 illustrated in FIG. 2, and display the image.

As the implementation forms of the memory 210, the communication interface 220, and the processor 230 are identical/similar to the implementation forms illustrated in FIG. 2, detailed explanation will be omitted.

According to an embodiment, the memory 210 may store information on a neural network model (or an artificial intelligence model) including a plurality of layers. Here, the feature of storing information on a neural network model may mean storing various types of information related to the operations of the neural network model, e.g., information on a plurality of layers included in the neural network model, information on parameters (e.g., filter coefficients, biases, etc.) used in each of the plurality of layers, etc. For example, the memory 210 may store information on a second neural network model that was trained to perform AI decoding according to an embodiment. Here, the second neural network model may be implemented as, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but is not limited thereto.

According to an embodiment, the memory 210 may store various types of information needed for image quality processing, e.g., information, an algorithm, an image quality parameter, etc. for performing at least one of noise reduction, detail enhancement, tone mapping, contrast enhancement, color enhancement, or frame rate conversion. Also, the memory 210 may store an AI-encoded image received from the first electronic device 100 and/or a final output image generated by image processing.

The processor 230 obtains an output image by performing image processing of an input image. Here, an input image or an output image may include a still image, a plurality of consecutive still images (or frames), or a video. The image processing may be digital image processing including at least one of image enhancement, image restoration, image transformation, image analysis, image understanding, or image compression. According to an embodiment, in case an input image is a compressed image that went through AI encoding, the processor 230 may release the compression by performing decoding and AI decoding of the compressed image, and then perform image processing. According to an embodiment, the processor 230 may perform image processing of an input image by using the neural network model. For example, for using the neural network model, the processor 230 may load information related to the neural network model stored in the memory 210, e.g., external memory such as DRAM, and use the information.

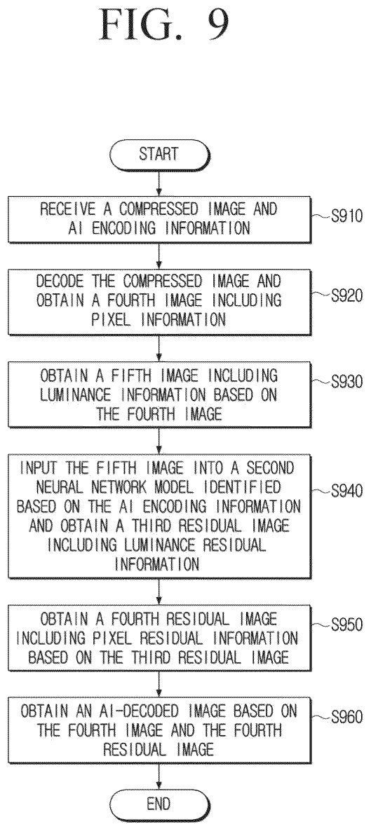

FIG. 9 is a flow chart for illustrating an operation of a second electronic device according to an embodiment of the disclosure.

The processor 230 may receive a compressed image and AI encoding information through the communication interface 220 in operation S910. For example, the processor 230 may receive a compressed image and AI encoding information from the first electronic device 100 illustrated in FIG. 2.

Then, the processor 230 may perform decoding (or the first decoding or video decoding) of the compressed image, and obtain a compression-released image (or a decoded image) (referred to as a fourth image hereinafter) in operation S920. Here, the fourth image may be an image including pixel information, e.g., an RGB image.

The decoding (or the first decoding or video decoding) process may include a process of performing entropy decoding of image data and generating quantized residual data, a process of inverse-quantizing the quantized residual data, a process of converting the residual data which is a frequency area component into a spatial area component, a process of generating prediction data, and a process of restoring the compression-released image by using the prediction data and the residual data, etc. Such a decoding process (or the first decoding) may be implemented through an image restoration method corresponding to one of image compression methods using frequency conversion such as MPEG-2, H.264, MPEG-4, HEVC, VC-1, VP8, VP9, and AV1, etc. used in the encoding process (or the first encoding) in the external first electronic device 100.

Then, the processor 230 may obtain a fifth image including luminance information based on the fourth image including pixel information in operation S930. For example, the pixel information may be R/G/B information, and accordingly, the fourth image may be implemented as an RGB image. The luminance information may include a Y value, and accordingly, the fifth image may be implemented as various images including the Y value. For example, the fifth image may be an RGB-Y image, but is not necessarily limited thereto.

Then, the processor 230 may identify a second neural network model based on the AI encoding information, and input the fifth image into the second neural network model and obtain a luminance residual image including luminance residual information (referred to as a third residual image hereinafter) in operation S940. Here, the AI encoding information may include operation setting information of the first neural network model used in the AI encoding in the first electronic device 100. The second neural network model may be a model that was trained to output a corresponding luminance residual image when an image including luminance information is input. For example, the second neural network model may be a model that was trained to output a luminance residual image by performing upsampling of an image through AI decoding. A luminance residual image may mean an image including only luminance residual information. For example, the luminance residual information may include YUV residual information. According to an embodiment, the processor 230 may identify operation setting information of the second neural network model based on at least one of information on an image size of the fifth image (and/or the fourth image), information on a network state, or information on a type of a codec. According to an embodiment, the processor 230 may identify operation setting information of the second neural network model based on information on an image size of the fifth image, information on a network state, and information on a type of a codec, and AI encoding information of the first electronic device 100.

Then, the processor 230 may obtain a fourth residual image including pixel residual information based on the third residual image in operation S950. For example, the processor 230 may convert the luminance residual information included in the third residual image into pixel residual information, and obtain the fourth residual image. For example, the luminance residual information may include YUV residual information. According to an embodiment, the processor 230 may obtain an R value, a G value, and a B value by applying conversion gains to a Y value, a U value, and a V value included in the third residual image, and obtain the obtained R value, G value, and B value as the pixel residual information.

Afterwards, the processor 230 may obtain an AI-decoded image based on the fourth image and the fourth residual image in operation S960.

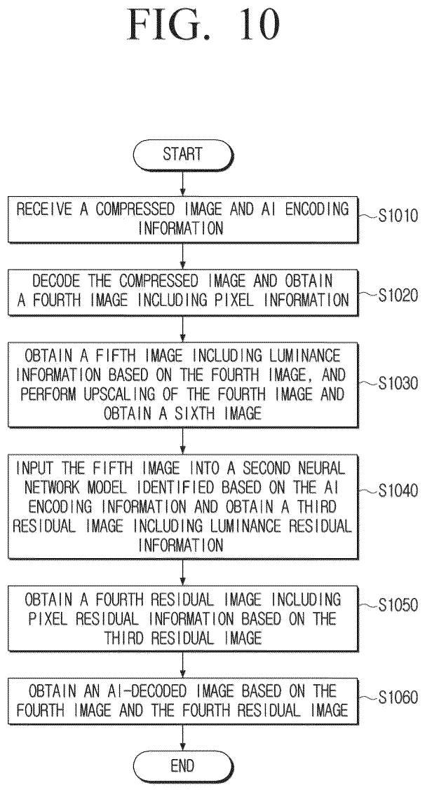

FIG. 10 is a flow chart for illustrating an operation of a second electronic device according to an embodiment of the disclosure.

According to FIG. 10, the processor 230 may receive a compressed image and AI encoding information through the communication interface 220 in operation S1010. For example, the processor 230 may receive a compressed image and AI encoding information from the first electronic device 100 illustrated in FIG. 2.

Then, the processor 230 may perform decoding (or the first decoding or video decoding) of the compressed image, and obtain a compression-released image (or a decoded image) (referred to as a fourth image hereinafter) in operation S1020. Here, the fourth image may be an image including pixel information, e.g., an RGB image.

Then, the processor 230 may obtain a fifth image including luminance information based on the fourth image including pixel information, and perform upscaling of the fourth image and obtain a sixth image in operation S1030. For example, the pixel information may be R/G/B information, and accordingly, the fourth image may be implemented as an RGB image. The luminance information may include a Y value, and accordingly, the fifth image may be implemented as various images including the Y value. For example, the fifth image may be an RGB-Y image, but is not necessarily limited thereto. According to an embodiment, the processor 230 may determine an upscaling ratio of the fourth image based on the upsampling ratio of the second neural network model.

Then, the processor 230 may identify a second neural network model based on the AI encoding information, and input the fifth image into the second neural network model and obtain a luminance residual image including luminance residual information (referred to as a third residual image hereinafter) in operation S1040. Here, the second neural network model may be a model that was trained to perform upsampling of an image through AI decoding. Accordingly, the processor 230 may input the fifth image into the second neural network model, and obtain the third residual image that was upsampled through the AI decoding.

Then, the processor 230 may obtain a fourth residual image including pixel residual information based on the third residual image in operation S1050. As the operation S1050 is identical to the operation S950, detailed explanation will be omitted.

Afterwards, the processor 230 may obtain an AI-decoded image based on the sixth image and the fourth residual image in operation S1060. As an example, the processor 230 may add pixel values included in the sixth image and pixel values included in the fourth residual image, and obtain an AI-decoded image. For example, the processor 230 may add each of pixel values included in the sixth image and pixel values included in the fourth residual image, and obtain an AI-decoded image of which size is identical to the sizes of the sixth image and the fourth residual image.

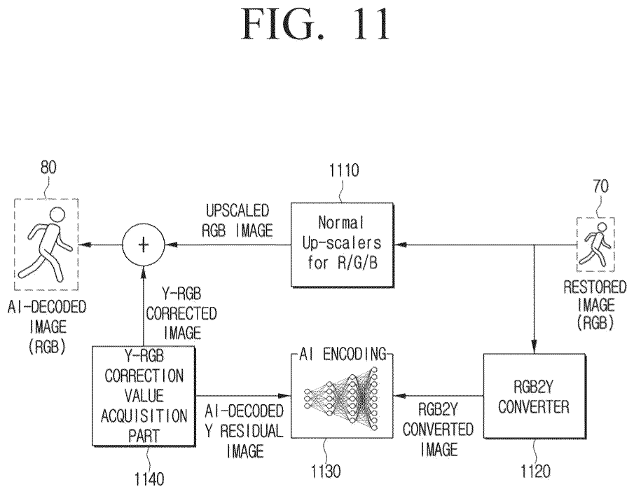

FIG. 11 is a diagram for illustrating in detail a method of generating an AI-encoded image according to an embodiment of the disclosure.

According to FIG. 11, the processor 130 may perform upscaling of a restored image 70 by using a normal upscaler 1110, and obtain an upscaled RGB image (a sixth image). Here, the restored image 70 may be a compression-released image (or a decoded image) (a fourth image) that was obtained by performing decoding (or the first decoding or video decoding) of a compressed image received from the first electronic device 100.

Also, the processor 130 may convert the input image, i.e., the restored image 70 (the fourth image) into an RGB-Y image (a fifth image) including luminance information by using an RGB2Y converter 1120. The RGB2Y converter 1120 may obtain luminance information for a plurality of color channels including RGB.

The processor 130 may input the RGB-Y converted image (the fifth image) into a second neural network model 1130 for AI decoding, and obtain an AI-encoded Y residual image (a third residual image). Here, the AI-encoded Y residual image may be an AI-encoded residual image regarding luminance. For example, the second neural network model 1130 may be a model that was trained to output an AI-encoded Y residual image (a third residual image) through AI encoding when an RGB-Y converted image (a fifth image) is input. The second neural network model 1130 may have a similar structure to that of the first neural network model illustrated in FIG. 7.

The processor 130 may obtain a Y-RGB corrected image (a fourth residual image) from the AI-encoded Y residual image (the third residual image) by using a Y-RGB correction value acquisition part 1140. For example, the Y-RGB correction value acquisition part 1140 may obtain a Y-RGB corrected image by using a predefined formula, an algorithm, etc. to pixel values included in an input RGB image. The Y-RGB corrected image may be an image including a correction value corresponding to a contribution amount of a luminance signal when converting the AI-encoded Y residual image into the original color gamut.

According to an embodiment, in the case of using a conversion formula of BT.709 as in the formula 1 above, the correction ratios of the AI-encoded Y residual image (the third residual image) for each of the R/G/B channels are 1:1:1, and the Y residual image can be scaled.

The processor 130 may add the pixel values of the upscaled RGB image (the sixth image) and the Y-RGB corrected image (the fourth residual image), and obtain an AI-decoded image 80 (an RGB image).

Meanwhile, although not illustrated in FIG. 8, the second electronic device 200 can obviously further include components such as a display (not shown), a user interface (not shown), a speaker (not shown), a camera (not shown), etc. depending on implementation examples.

According to the aforementioned various embodiments, AI encoding/decoding methods that can correspond to various three-dimensional color coordinates can be provided, and the processing amount can be reduced, and accordingly, the encoding and decoding efficiency can be improved. Specifically, it is possible to correspond to various three-dimensional color coordinates wherein luminance conversion is possible, and at the same time, the conventional processing process for a YUV image can be maintained. Also, as parameters of a neural network model can be commonly used without distinction in a color gamut, processing complexity does not increase.

Meanwhile, the methods according to the aforementioned various embodiments of the disclosure may be implemented in forms of applications that can be installed on conventional electronic devices. Alternatively, at least some of the methods according to the aforementioned various embodiments of the disclosure can be performed by using an artificial intelligence model based on deep learning, i.e., a learning network model.

Also, the methods according to the aforementioned various embodiment of the disclosure may be implemented just with software upgrade, or hardware upgrade for a conventional electronic device.

In addition, the aforementioned various embodiments of the disclosure may also be performed through an embedded server provided on an electronic device, or an external server of an electronic device.

Meanwhile, according to an embodiment of the disclosure, the aforementioned various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. Also, a storage medium that is readable by machines may be provided in the form of a non-transitory storage medium. Here, the term ‘non-transitory’ only means that a storage medium does not include signals and is tangible, and the term does not distinguish a case wherein data is stored in the storage medium semi-permanently and a case wherein data is stored in the storage medium temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the aforementioned various embodiments may include a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. In addition, operations performed by a module, a program, or other components according to the various embodiments may be executed sequentially, in parallel, repetitively, or heuristically. Or, at least some of the operations may be executed in a different order or omitted, or other operations may be added.

While embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device configured to process an image by using artificial intelligence (AI) encoding, comprising:
memory storing a first neural network model that is trained;
a communication interface; and
at least one processor configured,
wherein the memory stores instructions that, when executed by the at least one processor, cause the electronic device to:
obtain a second image including luminance information based on a first image including pixel information,
input the second image into the first neural network model and obtain a first residual image including luminance residual information,
obtain a second residual image including pixel residual information based on the first residual image,
obtain an AI-encoded image based on the first image and the second residual image, and
transmit, to an external device through the communication interface, a compressed image obtained by encoding the AI-encoded image.

2. The electronic device of claim 1, wherein the instructions, when executed by the at least one processor cause the electronic device to:
identify operation setting information of the first neural network model based on at least one of information about an image size of the second image, information about a network state, or information about a type of a codec, and
input the second image into the first neural network model to which the identified operation setting information is applied,
wherein the operation setting information comprises:
at least one of information about a number of layers of the first neural network model, information about a number of channels for each layer, information about a filter size, information about stride, information about pulling, or information about a parameter.

3. The electronic device of claim 2, wherein the instructions, when executed by the at least one processor cause the electronic device to:
identify the operation setting information of the first neural network model based on the information about the image size of the second image, the information about the network state, and the information about the type of the codec, and AI decoding information of the external device,
wherein the AI decoding information of the external device comprises:
operation setting information of a second neural network model used in the AI decoding in the external device, and
wherein the first neural network model is trained in association with the operation setting information of the second neural network model.

4. The electronic device of claim 2, wherein the instructions, when executed by the at least one processor cause the electronic device to:
perform downscaling of the first image and obtain a third image, and
obtain the AI-encoded image based on the third image and the second residual image.

5. The electronic device of claim 4, wherein the first neural network model is a model trained to perform downsampling of an image through AI encoding, and
wherein the instructions, when executed by the at least one processor cause the electronic device to:
input the second image into the first neural network model and obtain the first residual image downsampled through the AI encoding,
obtain the second residual image including pixel residual information based on the first residual image, and
add pixel values included in the third image and pixel values included in the second residual image and obtain the AI-encoded image.

6. The electronic device of claim 2, wherein the luminance residual information includes YUV residual information, and
wherein the instructions, when executed by the at least one processor cause the electronic device to:
obtain an R value, a G value, and a B value by applying conversion gains to a Y value, a U value, and a V value included in the first residual image, and
identify the obtained R value, G value, and B value as the pixel residual information.

7. An electronic device configured to process an image by using artificial intelligence (AI) decoding, comprising:
memory storing a trained second neural network model;
a communication interface; and
at least one processor,
wherein the memory stores instructions that, when executed by the at least one processor cause the electronic device to:
obtain a compressed image and AI encoding information through the communication interface,
decode the compressed image and obtain a fourth image including pixel information,
obtain a fifth image including luminance information based on the fourth image,
input the fifth image into a second neural network model identified based on the AI encoding information and obtain a third residual image including luminance residual information,
obtain a fourth residual image including pixel residual information based on the third residual image, and
obtain an AI-decoded image based on the fourth image and the fourth residual image.

8. The electronic device of claim 7, wherein the instructions, when executed by the at least one processor cause the electronic device to:
identify operation setting information of the second neural network model based on the AI encoding information, and
input the fifth image into the second neural network model to which the identified operation setting information is applied, and
wherein the operation setting information comprises:
at least one of information about a number of layers of the second neural network model, information about a number of channels for each layer, information about a filter size, information on stride, information about pulling, or information about a parameter.

9. The electronic device of claim 7, wherein the instructions, when executed by the at least one processor cause the electronic device to:
perform upscaling of the fourth image and obtain a sixth image, and
obtain the AI-decoded image based on the sixth image and the fourth residual image.

10. The electronic device of claim 9, wherein the second neural network model is a model trained to perform upsampling of an image through AI decoding, and
wherein the instructions, when executed by the at least one processor cause the electronic device to:
input the fifth image into the second neural network model and obtain the third residual image upsampled through AI decoding,
obtain the fourth residual image including pixel residual information based on the third residual image, and
add pixel values included in the sixth image and pixel values included in the fourth residual image and obtain the AI-encoded image.

11. The electronic device of claim 7, wherein the luminance residual information includes YUV residual information, and
wherein the instructions, when executed by the at least one processor cause the electronic device to:
obtain an R value, a G value, and a B value by applying conversion gains to a Y value, a U value, and a V value included in the third residual image, and
identify the obtained R value, G value, and B value as the pixel residual information.

12. A method for controlling an electronic device configured to process an image by using artificial intelligence (AI) encoding, the method comprising:
obtaining a second image including luminance information based on a first image including pixel information;
inputting the second image into a first neural network model that is trained and obtaining a first residual image including luminance residual information;
obtaining a second residual image including pixel residual information based on the first residual image;
obtaining an AI-encoded image based on the first image and the second residual image; and
transmitting, to an external device, a compressed image obtained by encoding the AI-encoded image.

13. The method of claim 12, wherein the obtaining the first residual image comprises:
identifying operation setting information of the first neural network model based on at least one of information about an image size of the second image, information about a network state, or information about a type of a codec; and
inputting the second image into the first neural network model to which the identified operation setting information is applied, and
the operation setting information comprises:
at least one of information about a number of layers of the first neural network model, information about a number of channels for each layer, information about a filter size, information about stride, information about pulling, or information about a parameter.

14. The method of claim 13, wherein the identifying the operation setting information of the first neural network model comprises:
identifying operation setting information of the first neural network model based on the information about the image size of the second image, the information about the network state, and the information about the type of the codec, and AI decoding information of the external device, and
the AI decoding information of the external device comprises:
operation setting information of a second neural network model used in the AI decoding in the external device, and
the first neural network model is trained in association with the operation setting information of the second neural network model.

15. The method of claim 12, wherein the method further comprises:
performing downscaling of the first image and obtaining a third image, and
wherein the obtaining the AI-encoded image comprises:
obtaining the AI-encoded image based on the third image and the second residual image.

16. The method of claim 15, wherein the first neural network model is a model trained to perform downsampling of an image through AI encoding, and
wherein the obtaining the first residual image comprises:
inputting the second image into the first neural network model and obtaining the first residual image downsampled through the AI encoding,
wherein the obtaining the second residual image comprises:
obtaining the second residual image including pixel residual information based on the first residual image, and
wherein the obtaining the AI-encoded image comprises:
adding pixel values included in the third image and pixel values included in the second residual image and obtaining the AI-encoded image.

17. The method of claim 16, wherein the luminance residual information includes YUV residual information, and
wherein the obtaining the second residual image comprises:
obtaining an R value, a G value, and a B value by applying conversion gains to a Y value, a U value, and a V value included in the first residual image, and
identifying the obtained R value, G value, and B value as the pixel residual information.

18. A method for controlling an electronic device configured to process an image by using artificial intelligence (AI) decoding, the method comprising:
receiving a compressed image and AI encoding information;
decoding the compressed image and obtaining a fourth image including pixel information;
obtaining a fifth image including luminance information based on the fourth image;
inputting the fifth image into a second neural network model identified based on the AI encoding information and obtaining a third residual image including luminance residual information;
obtaining a fourth residual image including pixel residual information based on the third residual image; and
obtaining an AI-decoded image based on the fourth image and the fourth residual image.

19. The method of claim 18, wherein the obtaining the AI-decoded image comprises:
performing upscaling of the fourth image and obtaining a sixth image, and
obtaining the AI-decoded image based on the sixth image and the fourth residual image.

20. The method of claim 19, wherein the second neural network model is a model trained to perform upsampling of an image through AI decoding, and
wherein the obtaining the third residual image comprises:
inputting the fifth image into the second neural network model and obtaining the third residual image upsampled through AI decoding,
wherein the obtaining the fourth residual image comprises:
obtaining the fourth residual image including pixel residual information based on the third residual image, and
wherein the obtaining the AI-decoded image comprises:
adding pixel values included in the sixth image and pixel values included in the fourth residual image and obtaining the AI-encoded image.
